(19) United States
(12) Patent Application Publication
(10) Pub. No.: US 2017/0090449 A1
(43) Pub. Date: Mar. 30, 2017

(54) METHOD FOR MANAGING AND CONFIGURING FIELD DEVICES OF AN AUTOMATION SYSTEM

(71) Applicant: ABB Schweiz AG, Baden (CH)

(72) Inventors: Dirk Wagener, Stadthagen (DE); Christioph Welte, Neu-Ulm (DE); Marcus Heege, Kaisersesch (DE); Wolfgang Mahnke, Hettenleidelheim (DE); Marko Schlueter, Espelkamp (DE)

(21) Appl. No.: 15/278,077

(22) Filed: Sep. 28, 2016

(30) Foreign Application Priority Data
Sep. 28, 2015 (DE) 10 2015 116 399.3

(51) Int. Cl. G05B 19/05; G05B 11/01

(52) U.S. Cl. CPC G05B 19/056; G05B 11/01; G05B 2219/13004

(57) ABSTRACT

A method for managing and configuring field devices of an automation system, wherein (1) a list of the texts contained in the field device-specific information package is generated in the predefined standard language using a configuration tool of the field device; (2) a text in a new language option is generated for each text in this list and assigned to the list; (3) queries regarding the execution time are made to the EDD in the standard language; (4) the responses to the queries are scanned for known texts in the predefined standard language and these texts are swapped for the texts in the new language option; and (5) the texts in the new language variant regarding the execution time of the field devices are displayed on a user interface of the configuration tool.

### CROSS-REFERENCE TO RELATED APPLICATIONS

Priority is claimed to German Patent Application No. DE 10 2015 116 399.3, filed on Sep. 28, 2015, the entire disclosure of which is hereby incorporated by reference herein.

### FIELD

The invention relates to a method for managing and configuring field devices of an automation system.

### BACKGROUND

Automation systems for controlling a technical process or a technical system typically comprise a control apparatus (PLC) that is integrated in a group of a plurality of smart electrical devices. Smart electronic devices are those based on microprocessors, such as protective gear and control devices, motor protection devices, smart switches and voltage regulators, frequency converters, pressure and temperature transmitters, flowmeters and actuators.

When configuring field devices using EDD (electronic device description) technology IEC 61804, a device manufacturer provides an EDD that contains information on the communication with the device and on the business logic and the user interfaces, i.e. which data entry masks should be displayed to a user. For example, the business logic includes which parameters may be written and when.

In addition to a single user element having various parameters, graphs and other elements, new windows and dialogs can also be defined in the EDD. In this case, a host has certain freedoms and can, for example, simultaneously display a plurality of menus defined in the EDD in various windows, as well as user interfaces of various device entities.

Known EDD host systems either restrict the number of windows or open any number of windows for the different devices. In the process, the overview of how the windows are assigned to the devices is lost.

According to the prior art, EDD host systems show the windows described in the EDD as windows of the application such that the user can compare the contents of a plurality of windows with one another. However, the windows can only be assigned to a particular device entity with difficulty, and assigning the windows to a particular input context of this device entity is even more difficult. If a user wishes to apply or discard an input context, it is thus hard to see which windows are affected.

In a programming tool of this kind, information on the devices is displayed and functions such as parameterizations are executed. For this purpose, the user first has to select a device from a plurality of devices.

Field devices are described by means of EDD files. The field device manufacturer is generally responsible for creating and managing the EDD files. These EDD files describe, inter alia, how a user interface of a field device is displayed. Said described user interface is formulated in a predefined standard language, for example English. Sometimes, few other language options are stored in the EDD file. An application can only use the languages specified in the EDD. The EDD files supplied are binary and thus cannot be expanded.

The availability of language options depends solely on the EDD file and thus on the languages that the field device manufacturer has defined and stored in the EDD. Any additional language not supported by the current EDD file has to be requested and ordered from the EDD manufacturer. Users find this a drawback.

### SUMMARY

An aspect of the invention provides a method for managing and configuring one or more field devices of an automation system having a configuration tool designed to physically detect a field device in the automation system, to logically integrate the field device in the automation system and to configure it in the automation system, the configuration tool drawing on, for this purpose, a predefined FDI information package that is specific to the field device and describes at least some functions and data of the field device, the method comprising: (1) generating a list of texts contained in a field device-specific FDI information package in a predefined standard language; (2) generating a text in a new language option for each text in the list from (1) and assigning the text in the new language option to the list; (3) making queries regarding an execution time to an EDD in the predefined standard language; (4) scanning responses to the queries for known texts in the predefined standard language and swapping the known texts for the texts in the new language option; and (5) displaying the texts in the new language option regarding the execution time of the one or more field devices on a user interface.

### BRIEF DESCRIPTION OF THE DRAWINGS

The present invention will be described in even greater detail below based on the exemplary figure. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 sequence of steps in a method according to the invention.

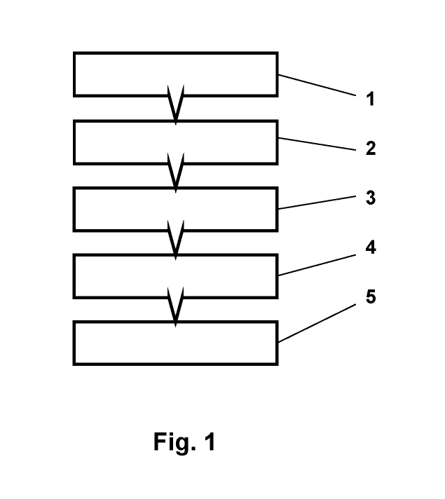

### DETAILED DESCRIPTION

An object of the invention is to provide any number of language options in an apparatus for managing and configuring field devices of an automation system, regardless of the language support in the EDD file.

According to an aspect, the invention relates to a method for managing and configuring field devices of an automation system, the method being used in particular in process automation or machine control for controlling processes and/or system components.

An aspect of the invention is based on a device for managing and configuring field devices of an automation system having a configuration tool designed to physically detect a field device in the automation system, to logically integrate said device in the automation system and to configure it in the automation system, wherein for this purpose the configuration tool draws on a predefined FDI information package that is specific to the field device and describes at least some of the functions and data of the field device.

According to an aspect of the invention, in a first step, a list of the texts contained in the field device-specific FDI information package is generated in the predefined standard language by means of the configuration tool. In a second step, a text in a new language option is generated for each text in this list and is assigned to said list. In a third step, queries regarding the execution time are made to the EDD in the standard language. In a fourth step, the responses to the queries are scanned for known texts in the predefined standard language and these texts are swapped for the texts in the new language option. In a fifth step, the texts in the new language option regarding the execution time of the field devices are displayed on the user interface of the configuration tool.

Advantageously, any number of other language options can be displayed, regardless of the language support implemented in the predefined field device-specific information package.

Aspects of the invention will be described in more detail below on the basis of an embodiment. The single figure shows the sequence of steps in the method according to the invention.

In a first step 1, a list of the texts contained in the field device-specific FDI information package is generated in the predefined standard language by means of the configuration tool.

In a second step 2, a text in a new language option is generated for each text in this list and is assigned to said list.

In a third step 3, queries regarding the execution time are made to the EDD in the standard language.

In a fourth step 4, the responses to the queries are scanned for known texts in the predefined standard language and these texts are swapped for the texts in the new language option.

In a fifth step 5, the texts in the new language option regarding the execution time of the field devices are displayed on the user interface of the configuration tool.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMERALS

1-4 step

1. A method for managing and configuring one or more field devices of an automation system having a configuration tool designed to physically detect a field device in the automation system, to logically integrate the field device in the automation system and to configure it in the automation system, the configuration tool drawing on, for this purpose, a predefined FDI information package that is specific to the field device and describes at least some functions and data of the field device, the method comprising:
(1) generating a list of texts contained in a field device-specific FDI information package in a predefined standard language;
(2) generating a text in a new language option for each text in the list from (1) and assigning the text in the new language option to the list;
(3) making queries regarding an execution time to an EDD in the predefined standard language;
(4) scanning responses to the queries for known texts in the predefined standard language and swapping the known texts for the texts in the new language option; and
(5) displaying the texts in the new language option regarding the execution time of the one or more field devices on a user interface.
